(19) United States
(12) Patent Application Publication
(10) Pub. No.: US 2025/0329239 A1
(43) Pub. Date: Oct. 23, 2025

(54) SMOKE DETECTING APPARATUS, CHAMBER THEREIN, AND FIRE DETECTING METHOD THEREOF

(71) Applicant: ELECTRONICS AND TELECOMMUNICATIONS RESEARCH INSTITUTE, Daejeon (KR)

(72) Inventors: Hoe-Sung Yang, Daejeon (KR); SOOCHEOL KIM, Daejeon (KR); KANG BOK LEE, Daejeon (KR); Jin Hwa RYU, Daejeon (KR); Yusun AHN, Daejeon (KR); Kwang-Soo CHO, Daejeon (KR); Kyu Won HAN, Daejeon (KR)

(21) Appl. No.: 19/182,392

(22) Filed: Apr. 17, 2025

(30) Foreign Application Priority Data
Apr. 22, 2024 (KR) 10-2024-0053231
Nov. 28, 2024 (KR) 10-2024-0173575

(51) Int. Cl. G08B 17/107; G01N 21/53

(52) U.S. Cl. CPC G08B 17/107; G01N 21/532

(57) ABSTRACT

Provided is a smoke detector chamber according to an embodiment disclosed in the present document, the smoke detector chamber including a scattering degree measuring device in a doughnut shape, which is provided with an intake port through which smoke particles are introduced or discharged, a plurality of light emitting units fixed to the scattering degree measuring device, each of which faces an area inside the intake port irradiated with light thereof and emits light, and a plurality of light receiving units that are fixed to the scattering degree measuring device such that light receiving areas thereof face inside of the intake port and, after the light is emitted, detect light scattered by the smoke particles, wherein the plurality of light emitting units and the plurality of light receiving units are spaced apart from each other to detect a specified angle-specific scattering degree.

### CROSS-REFERENCE TO RELATED APPLICATION

This application claims priority to and the benefit of Korean Patent Application Nos. 10-2024-0053231, filed on Apr. 22, 2024, and 10-2024-0173575, filed on Nov. 28, 2024, the disclosure of which is incorporated herein by reference in its entirety.

### BACKGROUND

### 1. Field of the Invention

Various embodiments disclosed herein relate to fire alarm technology.

### 2. Discussion of Related Art

Since fires cause casualties in addition to enormous property damage, fire detectors are installed in structures such as buildings to alarm occurrence of the fires. Accuracy of fire detection is required for the fire detectors to prevent no detection of the occurrence of fires or malfunctioning. Fire detection may be performed by a photoelectric smoke (fire) detector that detects scattering of light by smoke particles when the fires occur.

An example of a photoelectric smoke detector is a spot-type photoelectric smoke (fire) detector (or a general photoelectric detector) that generates an alarm based on smoke introduced into the detector by airflow when the fires occur. The spot-type photoelectric smoke (fire) detector may alarm the fires based on determination on whether an intensity of an optical signal scattered by smoke particles introduced into a chamber exceeds a threshold value.

However, the spot-type photoelectric smoke (fire) detector detects, as the fires, not fire smoke but fine particles, such as cooking smoke, cigarette smoke, water vapor, and fine dust, which are generated in a daily life, and generates an alarm (non-fire alarm).

Another example of the photoelectric smoke detector includes an air sampling smoke (fire) detector or an aspirating smoke (fire) detector, which may detect the fires early by suctioning air through a pipeline. The air sampling smoke (fire) detector may detect the fires early by suctioning air through a fan and quickly detecting smoke. The air sampling smoke detector may prevent non-fire alarm using a filter in an air suctioning process.

### SUMMARY OF THE INVENTION

However, an air sampling smoke detector may also generate a non-fire alarm due to similar smoke in daily life (cooking smoke, cigarette smoke, water vapor, or the like) in addition to dust. The non-fire alarm may waste dispatch administrative power of a fire station or make a fire manager insensitive to an alarm due to frequent false alarms. As a result, a situation in which the manager turns off a fire receiver may be caused, and thus actual occurrence of a fire cannot be detected, and serious casualties and property damage may be caused. Thus, measures are needed to increase accuracy of the smoke detector.

The present disclosure is directed to providing a smoke detecting apparatus capable of detecting a fire using a plurality of light emitting units and a plurality of light receiving units, a chamber therein, and a fire detecting method thereof.

According to an aspect of an embodiment, there is provided a smoke detector chamber including a scattering degree measuring device in a doughnut shape, which is provided with an intake port through which smoke particles are introduced or discharged, a plurality of light emitting units fixed to the scattering degree measuring device, each of which faces an area inside the intake port irradiated with light thereof and emits light, and a plurality of light receiving units that are fixed to the scattering degree measuring device such that light receiving areas thereof face inside of the intake port and, after the light is emitted, detect light scattered by the smoke particles, wherein the plurality of light emitting units and the plurality of light receiving units are spaced apart from each other to detect a specified angle-specific scattering degree.

According to another aspect of an embodiment, there is provided a smoke detecting apparatus including a chamber in a doughnut shape, which is provided with an intake port through which smoke particles are introduced or discharged, a plurality of light emitting units and a plurality of light receiving units being spaced apart from each other and fixed to the chamber to emit light toward the intake port and receive light through the intake port and a controller that detects whether a fire occurs based on an intensity of the light detected through the plurality of light receiving units and angles between the light emitting units and the light receiving units.

According to still another aspect of an embodiment, there is provided a method of detecting a fire by a smoke detecting apparatus including a chamber in a doughnut shape, which is provided with an intake port through which smoke particles are introduced or discharged, and a plurality of light emitting units and a plurality of light receiving units spaced apart from each other and fixed to the chamber to emit light toward the intake port and receive light through the intake port, the method including emitting light toward the intake port through the plurality of light emitting units, detecting the light emitted to the intake port and then scattered by the smoke particles in the intake port through the plurality of light receiving units, and detecting whether a fire occurs based on an intensity of the light detected through the plurality of light receiving units and angles between the light emitting units and the light receiving units.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram illustrating a physical scattering feature of light colliding with particles;

FIG. 2 illustrates types of scattering of light;

FIGS. 3 and 4 are exemplary diagrams of measurement of a light scattering degree in 0 degree direction by one light emitting unit and one light receiving unit;

FIG. 5 is an example of a method of measuring a scattering degree for each angle through one light emitting unit and one light receiving unit;

FIG. 6 is an example of a method of measuring a scattering degree for each angle through one light emitting unit and a plurality of light receiving units;

FIG. 7 illustrates a measurement timing of the light emitting unit and the light receiving unit for measuring a scattering degree in the method of FIG. 5;

FIG. 8 illustrates a measurement timing of the light emitting unit and the light receiving unit for measuring a scattering degree in the method of FIG. 6;

FIG. 9 illustrates a measurement timing of the light emitting unit and the light receiving unit for measuring a scattering degree in the method of FIG. 6 while one light emitting unit, a plurality of light receiving units, and an analog front end are included;

FIG. 10 is a configuration diagram of a smoke detecting apparatus according to an embodiment;

FIGS. 11A and 11B are structural diagrams of a scattering degree measuring device;

FIG. 12 illustrates an arrangement of the light emitting unit and the light receiving unit according to an embodiment;

FIG. 13 is a circuit diagram illustrating electrical connection between a detection controller, the light emitting units, and the light receiving units;

FIG. 14 illustrates control of control timing of the light emitting units, and the light receiving units by the detection controller;

FIGS. 15 to 18 are diagrams for describing a plurality of scattering angles according to an arrangement structure of light emitting units and light receiving units according to an embodiment;

FIG. 19 is a graph illustrating an angle (scattering angle)-specific scattering degree of single wavelength light;

FIG. 20 is a graph illustrating an angle-specific scattering degree of a single wavelength light by three different types of particles;

FIG. 21 illustrates a structural diagram of a smoke inhaler according to another embodiment on which the light emitting units and the light receiving units of a plurality of wavelengths may be seated;

FIG. 22 is a configuration diagram of a light-based smoke detecting apparatus of a plurality of wavelengths according to another embodiment;

FIG. 23 is a graph illustrating an angle-specific scattering degree of light having a plurality of wavelengths by specific particles;

FIG. 24 is a schematic flowchart of a fire detecting method according to the embodiment; and

FIG. 25 is a detailed diagram of the fire detecting method according to the embodiment.

In connection with the description of the drawings, the same or similar components may be designated by the same or similar reference numerals.

### DETAILED DESCRIPTION OF EXEMPLARY EMBODIMENTS

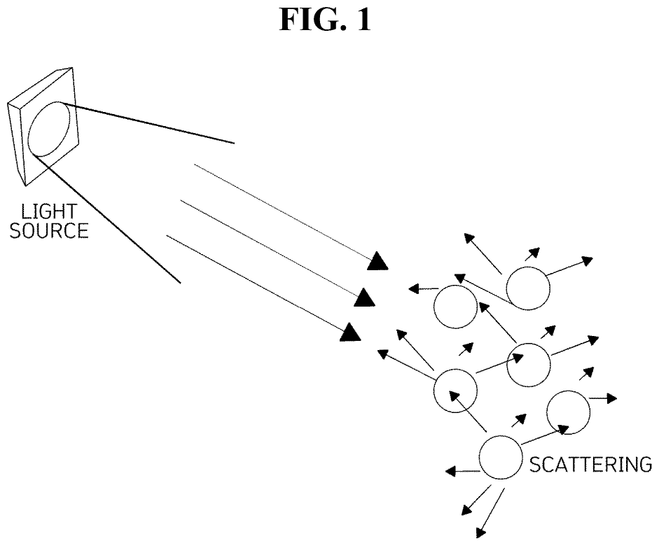

FIG. 1 is a conceptual diagram illustrating a physical scattering feature of light colliding with particles.

Referring to FIG. 1, when the light is emitted from a light source and passes through a medium in a straight line, a phenomenon (scattering of the light) in which the light deviates from a path may occur due to one or more local non-uniformities.

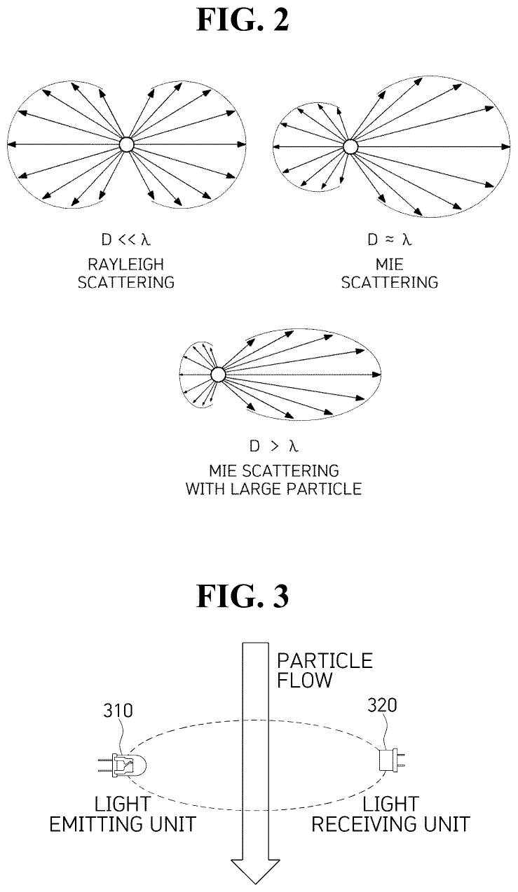

FIG. 2 illustrates types of scattering of light.

Referring to FIG. 2, the scattering of light may be roughly divided into three types according to wavelengths and particle sizes. In FIG. 2, D denotes a diameter of a particle, and λ denotes a wavelength of light.

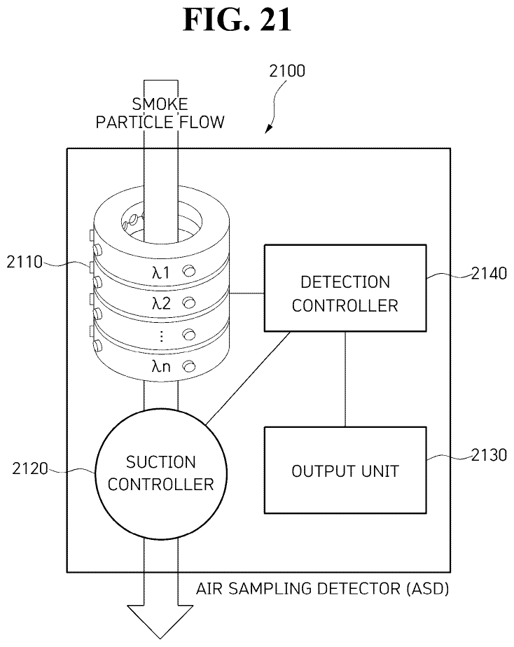

First, when the particle size is much smaller than the wavelength of light, Rayleigh scattering of light, which is elastic scattering, occurs. Second, when the particle size is similar to the wavelength of light, Mie scattering occurs. Finally, when the particle size is greater than the wavelength of the light source, Mie scattering with large particles occurs. In this way, the scattering of the light may be changed depending on the particle sizes and the wavelengths. Hereinafter, an embodiment in which a smoke detecting apparatus emits the light having a plurality of wavelengths and detects occurrence of fire based on the scattering degree for the plurality of wavelengths will be described with reference to FIGS. 21 to 23.

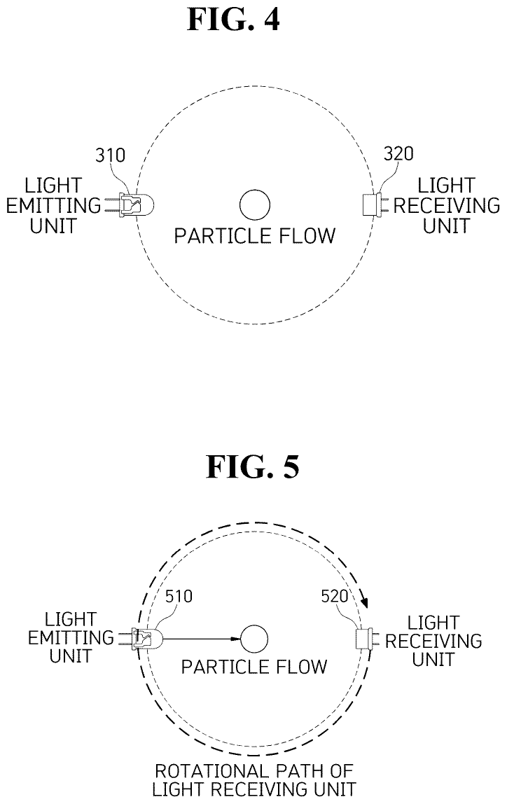

FIGS. 3 and 4 are exemplary diagrams of measurement of a light scattering degree in a 0 degree direction in the smoke detecting apparatus including one light emitting unit and one light receiving unit. In the present disclosure, for convenience of understanding the scattering angle, a position of the light receiving unit facing the light emitting unit is set to 0 degrees, and a position at which an angle gradually increases clockwise and then becomes 360 degrees is set to 0 degrees again. FIG. 3 is a diagram of the light emitting unit and the light receiving unit viewed from the side, and FIG. 4 is a diagram of the light emitting unit and the light receiving unit viewed from the above.

Referring to FIGS. 3 and 4, a light emitting unit 310 and a light receiving unit 320 may be arranged to face each other to emit and detect light in a direction perpendicular to a particle flow (e.g., flow of smoke particles). In this case, when there is no scattering of light due to the particle flow or the like, all the light emitted by the light emitting unit 310 should be detected by the light receiving unit 320. An intensity of light detected by the light receiving unit 320 may correspond to a light scattering degree when a light scattering angle is 0 degrees.

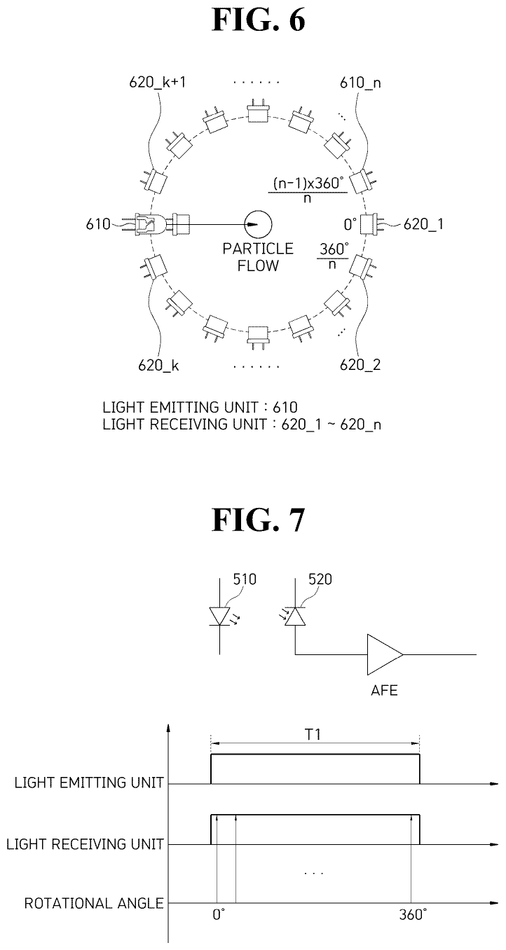

FIGS. 5 and 6 are exemplary diagrams of measuring an omnidirectional scattering angle for particles. FIG. 5 is example of measuring a scattering degree for each angle through one light emitting unit and one light receiving unit, and FIG. 6 is an example of measuring a scattering degree for each angle through one light emitting unit and a plurality of light receiving units.

Referring to FIG. 5, a light emitting unit 510 may be fixed to a chamber housing to emit the light toward a center of an intake port in the chamber. A light receiving unit 520 is disposed in the chamber housing to receive the light from at the center of the intake port in the chamber and may be physically rotated by a mechanical member. While an angle between the light emitting unit 510 and the light receiving unit 520 is changed through physical rotation, the omnidirectional scattering angle may be measured.

Referring to FIG. 6, when a plurality of light receiving units 620_1 to 620_n are arranged at equal angles to each other, the light scattering degree may be detected for each scattering angle at

$$\frac{360 °}{n}$$

intervals.

FIG. 7 illustrates a measurement timing of the light emitting unit and the light receiving unit for measuring a scattering degree in the method of FIG. 5.

Referring to FIG. 7, the light emitting unit 510 may emit the light during a first specified time T1. The light receiving unit 520 may detect the intensity of the light at a position of a specified rotational angle between 0 degrees and 360 degrees while rotating. An analog front end (AFE) is provided at a rear end of the light receiving unit 520 to amplify and digital-convert an optical signal detected by the light receiving unit 520. The first specified time may be set to be greater than or equal to a time during which the emitted light is detected by the light receiving unit 520 at positions of all specified rotational angles.

However, in a scattering degree measuring device configured such that the light receiving unit 520 rotates, an arrangement structure, rotation control, and light receiving timing control of the light emitting unit 510 and the light receiving unit 520 may be very complicated.

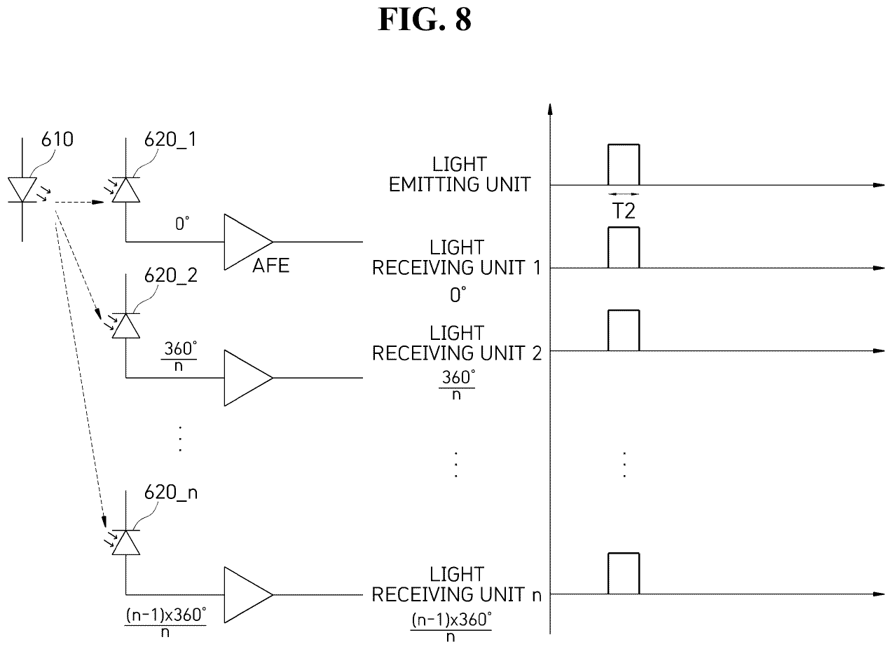

FIG. 8 illustrates a timing of measuring a scattering degree in the method of FIG. 6.

Referring to FIG. 8, a light emitting unit 610 may emit light during a second specified time T2 shorter than the first specified time. A plurality of light receiving units 610_1 to 610_n may detect light during the second specified time or a time similar thereto. The plurality of light receiving units 610_1 to 610_n may receive light during a second specified time or a similar time from 0° to

$$\frac{( n - 1 ) \times 360 °}{n}$$

at

$$\frac{360 °}{n}$$

intervals. The second specified time may be set to be greater than or equal to a time during which all the light receiving units 620 detect the light emitted by the light emitting unit 610.

The plurality of analog front ends (AFEs) may be provided at rear ends of the plurality of light receiving units 610_1 to 610_n to amplify an optical signal detected by the light receiving units 610_1 to 610_n. In this case, the plurality of light receiving units 610_1 to 610_n may simultaneously measure an angle-specific scattering degree, but hardware complexity (e.g., the number of elements and wiring lines) of the device may increase.

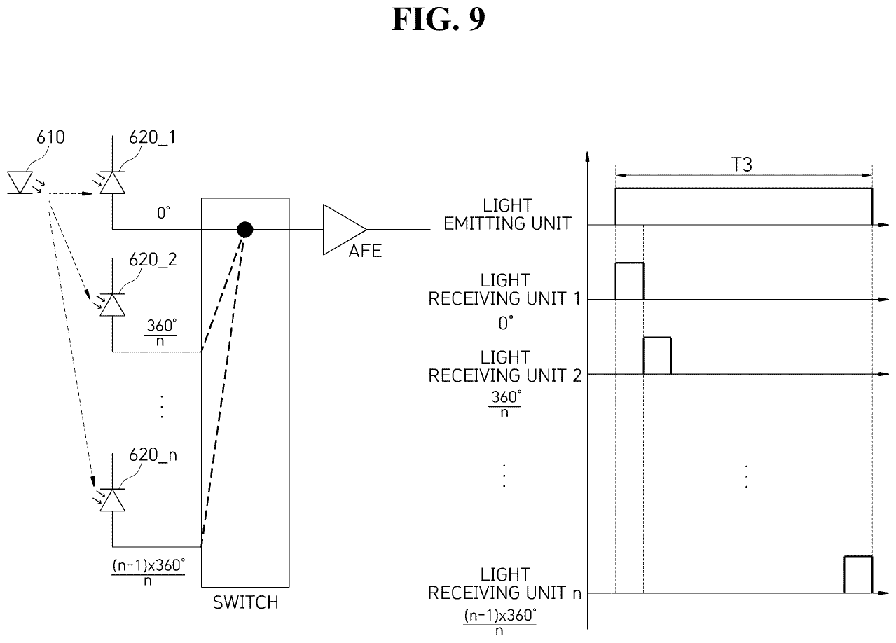

FIG. 9 illustrates a measurement timing of a scattering degree in a method while one light emitting unit, a plurality of light receiving units, and one analog front end are included. In the case of FIG. 9, since the one AFE is used, the number of hardware elements may be reduced as compared to the embodiment of FIG. 8.

In the case of FIG. 9, the light emitting unit 610 may emit the light during a third specified time T3, the plurality of light receiving units 620 may be sequentially switched, and thus the angle-specific scattering degree may be detected. The third specified time may be set to be greater than or equal to a time during which the light emitted by the light emitting unit 610 is detected by the light receiving units 620_1 to 620_n.

According to various embodiments, n light emitting units may be arranged at regular intervals, the light emitting units may be sequentially switched, and an angle-specific scattering degree may be measured from 0° to

$$\frac{( n - 1 ) \times 360 °}{n}$$

at

$$\frac{360 °}{n}$$

intervals by the one light receiving unit.

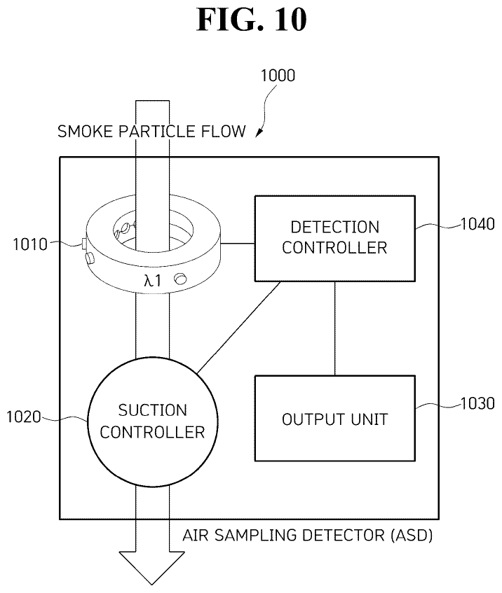

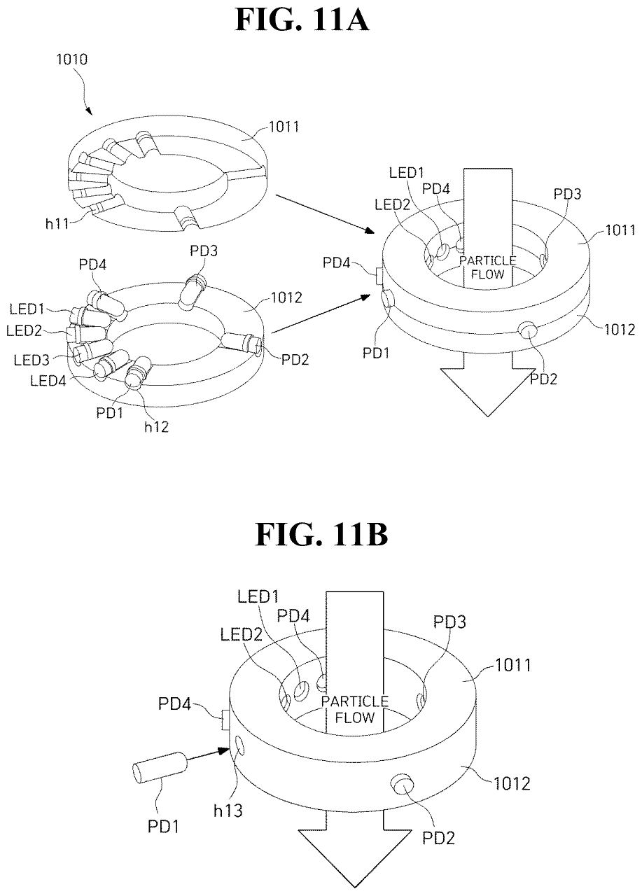

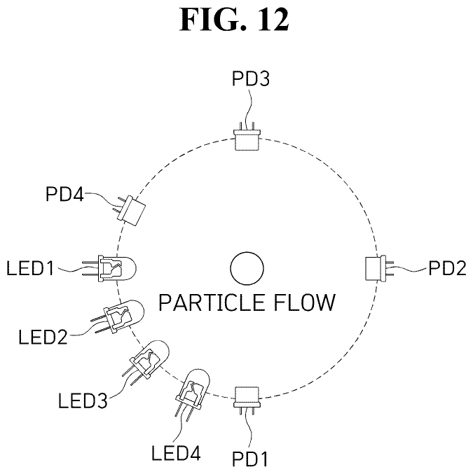

FIG. 10 is a configuration diagram of a smoke detecting apparatus according to an embodiment. FIGS. 11A and 11B are structural diagrams of a scattering degree measuring device according to the embodiment, and FIG. 12 illustrates an arrangement of the light emitting unit and the light receiving unit according to an embodiment.

Referring to FIGS. 10 to 12, the smoke detecting apparatus 1000 according to the embodiment may include a scattering degree measuring device 1010, a plurality of light emitting units LED1, LED2, LED3, and LED4, a plurality of light receiving units PD1, PD2, PD3, and PD4, and a detection controller 1040. In the embodiment, in the smoke detecting apparatus 1000, some components may be omitted or additional components may be further included. For example, the smoke detecting apparatus 1000 may further include a suction controller 1020, a memory (not illustrated), and an output unit 1030. Further, some of the components of the smoke detecting apparatus 1000 may be coupled to constitute one object, and functions of the corresponding components before the coupling may be performed in the same manner.

The scattering degree measuring device 1010 is formed in an annular shape (or a donut shape) provided with an intake port through which smoke particles are introduced or discharged. The scattering degree measuring device 1010 may include areas in which the plurality of light emitting units LED1, LED2, LED3, and LED4 and the plurality of light receiving units PD1, PD2, PD3, and PD4 are seated or fixed. The scattering degree measuring device 1010 may be a chamber (cylindrical shape) of the smoke detecting apparatus 1000 or may constitute at least a passage of a portion of the cylindrical chamber through which smoke particles are introduced. For example, the scattering degree measuring device 1010 may be provided in an inner area of the intake port of the chamber.

Referring to FIG. 11A, the scattering degree measuring device 1010 may include an upper plate member 1011 and a lower plate member 1012. The upper plate member 1011 has a plurality of first grooves h11 on which some areas of the plurality of light emitting units LED1, LED2, LED3, and LED4 and some areas of the plurality of light receiving units PD1, PD2, PD3, and PD4 are seated. The first grooves h11 may be formed as many as the numbers of the plurality of light emitting units LED1, LED2, LED3, and LED4 and the plurality of light receiving units PD1, PD2, PD3, and PD4.

The lower plate member 1012 may have a plurality of second grooves h12 on which the other areas of the plurality of light emitting units LED1, LED2, LED3, and LED4 and the other areas of the plurality of light receiving units PD1, PD2, PD3, and PD4 are seated. When the upper plate member 1011 and the lower plate member 1012 overlap each other, the first grooves h11 and the second grooves h12 face each other, and the light emitting units LED1, LED2, LED3, and LED4 and the light receiving units PD1, PD2, PD3, and PD4 may be seated in a space provided by the first grooves h11 and the second grooves h12.

Unlike this, as illustrated in FIG. 11B, the scattering degree measuring device 1010 may be an integrated member including a plurality of holes (e.g., h13) corresponding to coupling of the first grooves h11 and the second grooves h12. The light emitting units LED1, LED2, LED3, and LED4 and the light receiving units PD1, PD2, PD3, and PD4 may be seated in each of the holes (e.g., h13).

The suction controller 1020 may control smoke particles to be introduced into the intake port of the scattering degree measuring device 1010. For example, the suction controller 1020 may include a member (e.g., a motor and a fan) that causes air flow from one end to the other end of the intake port, and when power is applied, may constantly introduce smoke particles into the intake port.

The plurality of light emitting units LED1, LED2, LED3, and LED4 may be fixed to the scattering degree measuring device 1010 and face an area inside the intake port irradiated with light thereof. The plurality of light receiving units PD1, PD2, PD3, and PD4 may be fixed to the scattering degree measuring device 1010 such that light receiving areas thereof face the inside of the intake port.

The plurality of light emitting units LED1, LED2, LED3, and LED4 and the plurality of light receiving units PD1, PD2, PD3, and PD4 may be spaced apart from each other to detect a light scattering degree for each specified angle. For example, one of the plurality of light emitting units LED1, LED2, LED3, and LED4 and one of the plurality of light emitting units LED1, LED2, LED3, and LED4 may be arranged to face each other, and the others of the plurality of light emitting units LED1, LED2, LED3, and LED4 and the others of the plurality of light emitting units LED1, LED2, LED3, and LED4 may be arranged not to face each other.

Referring to FIG. 12, four light emitting units LED1, LED2, LED3, and LED4 and four light receiving units PD1, PD2, PD3, and PD4 may be provided. In this case, the first light emitting unit LED1 and the second light receiving unit PD2 may face each other. The first light receiving unit PD1 may be disposed at one side between the first light emitting unit LED1 and the second light receiving unit PD2. And the third and fourth light receiving units LED3 and LED4 may be arranged on the other side between the first light emitting unit LED1 and the second light receiving unit PD2. Further, the second to fourth light emitting units LED2, LED3, and LED4 may be arranged between the first light emitting unit LED1 and the first light receiving unit PD1.

The output unit 1030 may include at least one of a light emitting diode (LED), a display, and a flexible numeric display (FND) for outputting a warning sound, a warning lamp, an image, or a text under control of the detection controller 1040. The output unit 1030 may include, for example, at least one of a display, a light emitting diode, and a speaker.

The detection controller 1040 may control at least one other component (e.g., a hardware or software component) of the smoke detecting apparatus 1000 and may perform various data processing or operations. For example, the detection controller 1040 may include at least one of a central processing unit (CPU), a graphics processing unit (GPU), a microprocessor, an application processor, and an on-demand semiconductor (application specific integrated circuit (ASIC) and field programmable gate array (FPGA)) and may have a plurality of cores.

According to the embodiment, the detection controller 1040 may control the suction controller 1020 so that smoke particles are constantly introduced into the intake port. Unlike this, when only power is applied to the suction controller 1202 without the control of the detection controller 1040, the suction controller 1020 may operate to constantly suction smoke particles.

The detection controller 1040 may identify whether a fire occurs at each specified period based on smoke particles that are (constantly) suctioned. At the specified period, the detection controller 1040 may sequentially emit the light using the light emitting units LED1, LED2, LED3, and LED4 and may detect scattering degrees of the light emitted by the light emitting units LED1, LED2, LED3, and LED4 through the plurality of light receiving units PD1, PD2, PD3, and PD4. For example, when there are four light emitting units and four light receiving units, the detection controller 1040 may sequentially emit the light one by one through the light emitting units and detect the light emitted by the light emitting units through the four light receiving units.

When the detection controller 1040 emits the light through all the light emitting units and detects the scattering degrees thereof by the plurality of light receiving units PD1, PD2, PD3, and PD4, a detected angle-specific scattering degree pattern may be identified. Here, the detection controller 1040 may identify the scattering degree of the light for each angle by synthesizing (e.g., averaging) the scattering degree patterns of overlapping angles. For example, the detection controller 1040 may determine whether the fire occurs based on the intensity of the light detected through the plurality of light receiving units PD1, PD2, PD3, and PD4 and angles between the light emitting units and the light receiving units. Here, the angles between the light emitting units LED1, LED2, LED3, and LED4 and the light receiving units PD1, PD2, PD3, and PD4 may be an angle between a first straight line connecting a reference point (e.g., center) of the scattering degree measuring device 1010 in the intake port and the light emitting units LED1, LED2, LED3, and LED4 and a second straight line connecting the reference point and the light receiving units PD1, PD2, PD3, and PD4. The angles are previously determined according to the arrangement of the light emitting units LED1, LED2, LED3, and LED4 and the light receiving units PD1, PD2, PD3, and PD4 and may be stored in a memory (e.g., the detection controller 1040).

The detection controller 1040 may identify similarity between the detected angle-specific scattering degree pattern and a comparison target pattern and identify whether the identified similarity is greater than or equal to a specified reference value. The comparison target pattern may be, for example, the scattering degree pattern of light scattered by fire smoke. In various embodiments, the scattering degree pattern of light due to the fire smoke may be different depending on cause of the fire. Thus, when the comparison target pattern for each fire cause is used, the detection controller 1040 may predict whether the fire occurs as well as the cause of the fire.

When it is identified that the identified similarity is greater than or equal to a specified reference value, the detection controller 1040 may determine that the fire occurs. When it is determined that the fire occurs, the detection controller 1040 may output a fire alarm through the output unit 1030.

On the other hand, when it is determined that the identified similarity is smaller than the specified reference value, the detection controller 1040 may stop the control of the light emitting units LED1, LED2, LED3, and LED4 and the light receiving units PD1, PD2, PD3, and PD4 for detecting the fire at a current period and may wait until a next period.

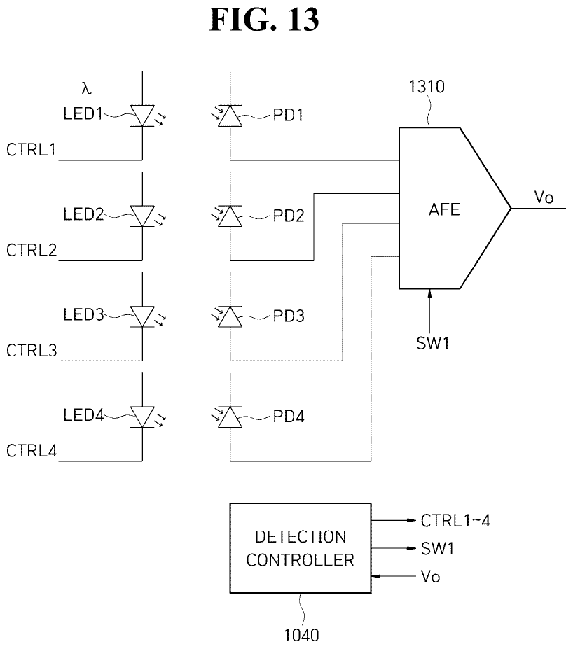

According to various embodiments, the plurality of light emitting units LED1, LED2, LED3, and LED4 may emit light having a single wavelength or light having a plurality of wavelengths. When the plurality of light emitting units LED1, LED2, LED3, and LED4 emit light having the plurality of wavelengths, the detection controller 1040 may calculate the angle-specific scattering degree pattern for each individual wavelength. Hereinafter, a smoke detecting apparatus using light having a single wavelength will be first described with reference to FIGS. 13 to 20. Thereafter, an embodiment in which light having a plurality of wavelengths is used will be described later with reference to FIGS. 21 to 23.

According to various embodiments, the detection controller 1040 may predict the cause of the fire based on the angle-specific scattering degree using the comparison target pattern determined as the angle-specific scattering degree due to the fire smoke according to the cause of the fire is learned in advance. The detection controller 1040 may output the cause of the fire through the output unit 1030 or provide fire cause information to a user through a communication channel.

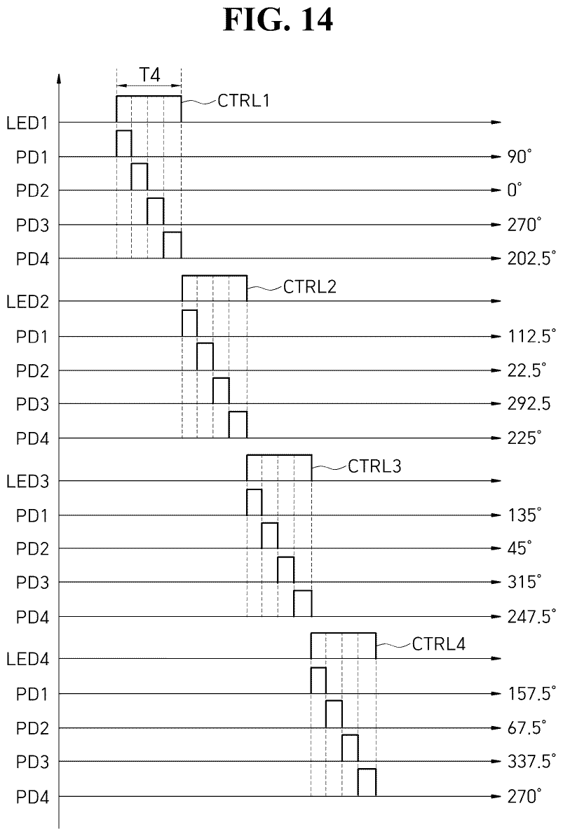

Hereinafter, the control of the light emitting units and the light receiving units by the detection controller according to the embodiment will be described with reference to FIGS. 13 and 14. FIG. 13 is a circuit diagram illustrating electrical connection between a detection controller, the light emitting units, and the light receiving units, and FIG. 14 illustrates control timing of the light emitting units, and the light receiving units by the detection controller.

Referring to FIG. 13, the smoke detecting apparatus 1000 may further include an AFE element 1310. Further, the smoke detecting apparatus 1000 may further include a power supply element for supplying power to each circuit element.

According to the embodiment, the detection controller 1040 may selectively output first to fourth control signals CTRL1 to CTRL4 for emitting light through the first to fourth light emitting units LED1, LED2, LED3, and LED4 through first to fourth output terminals (e.g., GPIO). For example, when the first to fourth control signals CTRL1 to CTRL4 are output during a fourth specified time T4, the first light emitting unit LED1, the second light emitting unit LED2, the third light emitting unit LED3, and the fourth light emitting unit LED4 may sequentially emit the light during the fourth specified time T4. There may be a certain delay time between the first to fourth control signals CTRL1 to CTRL4, and in this case, the first to fourth light emitting units LED1, LED2, LED3, and LED4 operated by the control signals CTRL1 to CTRL4 may be operated to be delayed by the delay time.

In the embodiment, a switching transistor for lighting the plurality of light emitting units LED1, LED2, LED3, and LED4 according to the first to fourth control signals may be further connected between the first to fourth output terminals and the plurality of light emitting units LED1, LED2, LED3, and LED4. The fourth specified time may be set to be greater than or equal to a time during which light emitted by the first to fourth light emitting units LED1, LED2, LED3, and LED4 is scattered by smoke particles and is then detected by the first to fourth light receiving units PD1, PD2, PD3, and PD4.

According to the embodiment, the AFE element 1310 may receive an optical signal from the first to fourth light receiving units PD1, PD2, PD3, and PD4 as an input. The AFE element 1310 may amplify the input optical signal, convert the amplified optical signal into a digital format, and output the converted optical signal. For example, the AFE element 1310 may sequentially amplify optical signals from the first to fourth light receiving units PD1, PD2, PD3, and PD4 one by one, convert the amplified optical signals into a digital format, and output the converted optical signals according to the control of the detection controller 1040 (timing control signal SW1). In this regard, the AFE element 1310 may include a current source that selectively supplies a current to the first to fourth light receiving units PD1, PD2, PD3, and PD4, an amplifier that amplifies the optical signal from a light receiving unit, which receives the current, among the first to fourth light receiving units PD1, PD2, PD3, and PD4, and a converter that converts the amplified optical signal into a digital format.

Referring to FIG. 14, while the first control signal CTRL1 is output and the first light emitting unit LED1 emits the light, the detection controller 1040 may output (be input) digital signals corresponding to the optical signals through the first to fourth light receiving units PD1, PD2, PD3, and PD4. Similarly, while the second to fourth control signals CTRL2 to CTRL4 are sequentially output for the fourth specified time T4, the detection controller 1040 may sequentially (digital-convert and) output (be input) the optical signals detected by the first to fourth light receiving units PD1, PD2, PD3, and PD4 for the third specified time (T4/4 or less).

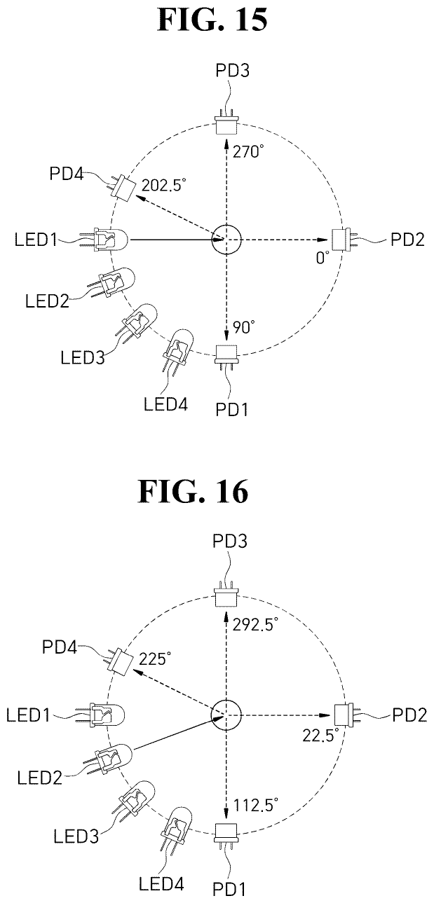

FIGS. 15 to 18 are diagrams for describing a plurality of scattering angles according to an arrangement structure of light emitting units and light receiving units according to an embodiment.

In the present disclosure, for convenience of understanding the scattering angle, a position of the second light receiving unit PD2 opposite to the first light emitting unit LED1 is set to be 0 degrees, the angle is set to increase clockwise based on 0 degrees, and a point at which the angle is gradually increased and becomes 360 degrees is set to be 0 degrees again.

Referring to FIGS. 14 and 15, when light is emitted by the first light emitting unit LED1, the scattering angle of light detected by the first light receiving unit PD1 may be 90 degrees, the scattering angle of light detected by the second light receiving unit PD2 may be 0 degrees, the scattering angle of light detected by the third light receiving unit PD3 may be 270 degrees, and the scattering angle of light detected by the fourth light receiving unit PD4 may be 202.5 degrees.

Referring to FIGS. 14 and 16, when light is emitted by the second light emitting unit LED2, the scattering angle of light detected by the first light receiving unit PD1 may be 112.5 degrees, the scattering angle of light detected by the second light receiving unit PD2 may be 22.5 degrees, the scattering angle of light detected by the third light receiving unit PD3 may be 292.5 degrees, and the scattering angle of light detected by the fourth light receiving unit PD4 may be 225 degrees.

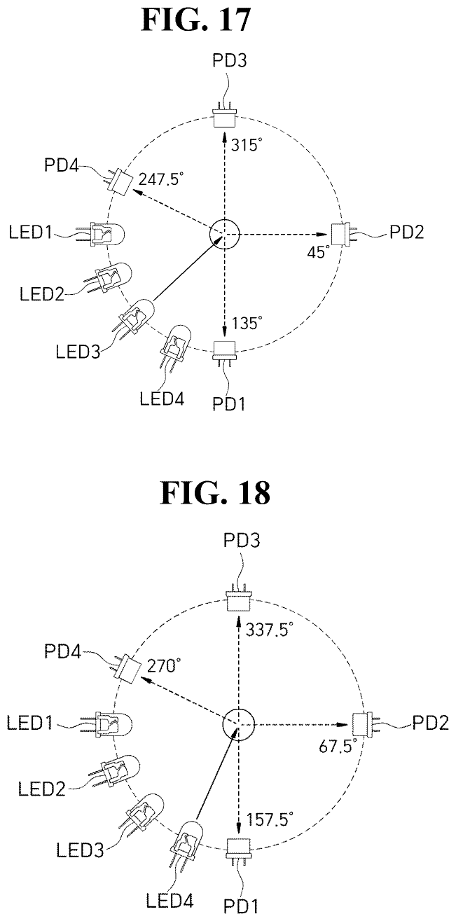

Referring to FIGS. 14 and 17, when light is emitted by the third light emitting unit LED3, the scattering angle of light detected by the first light receiving unit PD1 may be 135 degrees, the scattering angle of light detected by the second light receiving unit PD2 may be 45 degrees, the scattering angle of light detected by the third light receiving unit PD3 may be 315 degrees, and the scattering angle of light detected by the fourth light receiving unit PD4 may be 247.5 degrees.

Referring to FIGS. 14 and 18, when light is emitted by the fourth light emitting unit LED4, the scattering angle of light detected by the first light receiving unit PD1 may be 157.5 degrees, the scattering angle of light detected by the second light receiving unit PD2 may be 67.5 degrees, the scattering angle of light detected by the third light receiving unit PD3 may be 337.5 degrees, and the scattering angle of light detected by the fourth light receiving unit PD4 may be 270 degrees.

In the arrangement structure of FIGS. 15 to 18, the light scattering angle of 270 degrees may be detected twice. In this case, the detection controller 1040 may synthesize (e.g., average) the scattering degrees of the scattering angles of the light detected twice or may select one of the two degrees.

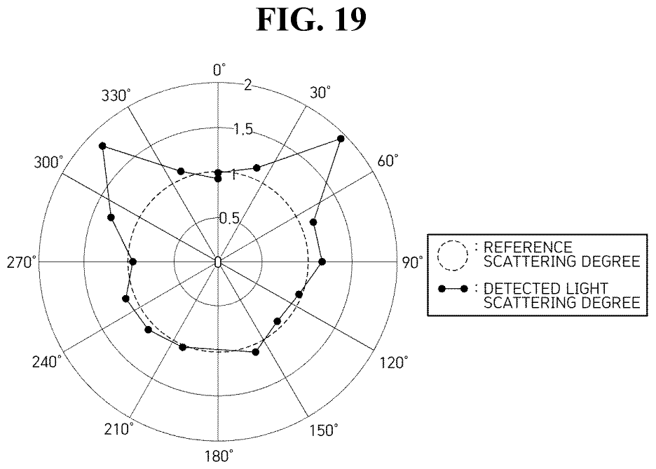

FIG. 19 is a graph illustrating an angle (scattering angle)-specific scattering degree of single wavelength light. In FIG. 19, a reference scattering degree may be a scattering degree pattern when the light from the light emitting unit is uniformly scattered in all directions.

Referring to FIG. 19, it may be identified that the angle (scattering angle)-specific scattering degree of the light has a pattern due to smoke introduced into the intake port.

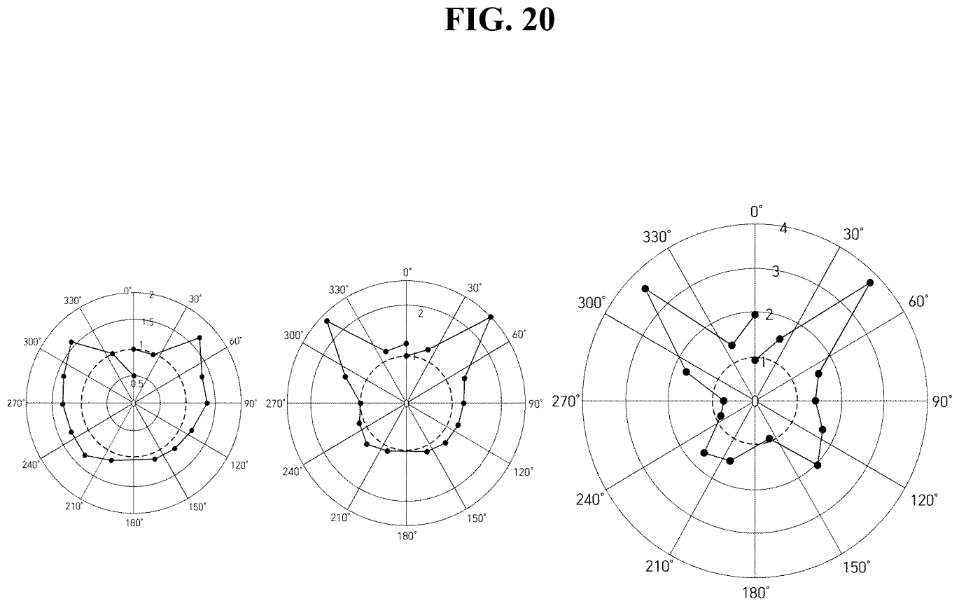

FIG. 20 is a graph illustrating an angle-specific scattering degree of a single wavelength light by three different types of particles.

Referring to FIG. 20, it may be identified that the scattering degree of the single wavelength light changes depending on the type of particles introduced into the intake port.

In this way, the smoke detecting apparatus 1000 according to the embodiment may accurately distinguish a fire and a non-fire from each other by analyzing different scattering characteristics between the angle-specific scattering degree of the light due to the fire smoke and the angle-specific scattering degree by smoke particles having different transmittances. Accordingly, the smoke detecting apparatus 1000 according to the embodiment may avoid a firefighter from being incorrectly dispatched due to a false fire alarm in advance and may increase reliability of a fire alarm of the general public.

Furthermore, the smoke detecting apparatus 1000 according to the embodiment may predict the cause of the fire and provide the predicted cause to the firefighter based on the angle-specific scattering degree of the light due to the fire smoke when the particles of the fire smoke according to a fire source are different, so that the firefighter may prepare for a fire suppression measure for the cause of the fire.

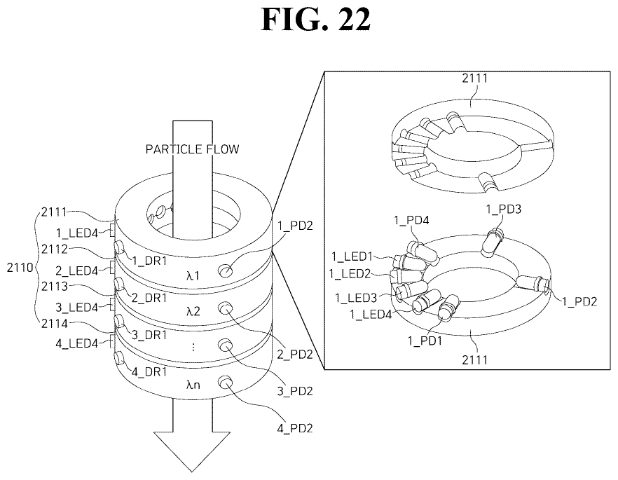

Hereinafter, a smoke detecting apparatus according to another embodiment in which the light having a plurality of wavelengths is used will be described with reference to FIGS. 21 to 23. FIG. 21 illustrates a structural diagram of a smoke inhaler according to another embodiment on which the light emitting units and the light receiving units of a plurality of wavelengths may be seated. And FIG. 22 is a configuration diagram of a light-based smoke detecting apparatus of a plurality of wavelengths according to another embodiment.

Referring to FIGS. 21 to 22, a smoke detecting apparatus 2100 according to another embodiment may include another scattering degree measuring device 2110, a plurality of light emitting units 1_LED1 to 1_LED4, 2_LED1 to 2_LED4, 3_LED1 to 3_LED4, and 4_LED1 to 4_LED4, a plurality of light receiving units 1_PD1 to 1_PD4, 2_PD1 to 2_PD4, 3_PD1 to 3_PD4, and 4_PD1 to 4_PD4, a suction controller 2120, an output unit 2130, and a detection controller 2140. In another embodiment, in the smoke detecting apparatus 2100, some components may be omitted or additional components may be further included. Further, some of the components of the smoke detecting apparatus 2100 may be coupled to constitute one object, and functions of the corresponding components before the coupling may be performed in the same manner. The smoke detecting apparatus 2100 according to another embodiment partially differs from the smoke detecting apparatus 1000 according to the embodiment in terms of the structure of another scattering degree measuring device 2110 as the light having a plurality of wavelengths is used to measure the scattering degree of the light. Thus, in the smoke detecting apparatus 2100 according to another embodiment, a different component, e.g., another scattering degree measuring device 2110 will be mainly described.

Referring to FIG. 22, another scattering degree measuring device 2110 may be formed by coupling of a plurality of annular members 2111 to 2114 on which a plurality of groups of detection elements 1 to 4_LED1 to 4 and 1 to 4_PD1 to 4 corresponding to the number of wavelengths (n is a constant of 2 or more) for emitting and detecting the light having a plurality of wavelengths are seated. The plurality of annular members 2111, 2112, 2113, and 2114 may be stacked in a direction in which flow of particles of air is generated and may include the plurality of groups of detection elements 1 to 4_LED1 to 4 and 1 to 4_PD1 to 4, respectively. The plurality of groups of detection elements 1 to 4_LED1 to 4 and 1 to 4_PD1 to 4 may include group-specific light emitting units and group-specific light receiving units. The group-specific detection elements 1 to 4_LED1 to 4 and 1 to 4_PD1 to 4 may be provided at positions corresponding to each other to detect scattering degrees at the same angle at different wavelengths. In FIGS. 21 and 22, a case in which n is 4 will be described as an example. However, it is not limited thereto.

For example, the first annular member 2111 may fix the first group-light emitting units (e.g., 1_LED1 to 4) and the first group-light receiving units (e.g., 1_PD1 to 4). The first group-light emitting units (e.g., 1_LED1 to 4) may sequentially emit light having a first wavelength, and the first group-light receiving units (e.g., 1_PD1 to 4) may detect the light having the first wavelength emitted by the first group-light emitting units. The second annular member 2112 may fix the second group-light emitting units (e.g., 2_LED1 to 4) and the second group-light receiving units (e.g., 2_PD1 to 4). The second group-light emitting units (e.g., 2_LED1 to 4) may sequentially emit light having a second wavelength, and the second group-light receiving units (e.g., 2_PD1 to 4) may detect the light having the second wavelength emitted by the second group-light emitting units. The third annular member 2113 may fix the third group-light emitting units (e.g., 3_LED1 to 4) and the third group-light receiving units (e.g., 3_PD1 to 4). The third group-light emitting units (e.g., 3_LED1 to 4) may sequentially emit light having a third wavelength, and the third group-light receiving units (e.g., 3_PD1 to 4) may detect the light having the third wavelength emitted by the third group-light emitting units. The fourth annular member 2114 may fix the fourth group-light emitting units (e.g., 4 LED1 to 4) and the fourth group-light receiving units (e.g., 4_PD1 to 4). The fourth group-light emitting units (e.g., 4_LED1 to 4) may sequentially emit light having a fourth wavelength, and the fourth group-light receiving units (e.g., 4_PD1 to 4) may detect the light having the fourth wavelength emitted by the fourth group-light emitting units.

According to the embodiment, the detection controller 2140 may emit light having different wavelengths using the plurality of light emitting units 1_LED1 to 4, 2_LED1 to 4, 3_LED1 to 4, and 4_LED1 to 4 and may measure the scattering degree further based on the wavelength of light detected by the plurality of light receiving units 1_PD1 to 4, 2_PD1 to 4, 3_PD1 to 4, and 4_PD1 to 4. For example, the detection controller 2140 may detect the light having the plurality of wavelengths using a plurality of groups of light receiving units (e.g., 1 to 4_PD1 to 4) while emitting light having individual wavelengths through the light emitting units (e.g., 1 to 4_LED1 to 4) at corresponding positions among the light emitting units (1_LED1 to 4, 2_LED1 to 4, 3_LED1 to 4, and 4_LED1 to 4) of each group. For example, the first group-light emitting units (e.g., 1_LED1 to 4) may sequentially emit the light having the first wavelength, and the first group-light receiving units (e.g., 1_PD1 to 4) may detect the light having the first wavelength emitted by the first group-light emitting units. The detection controller 2140 may calculate the angle-specific scattering degree for the light having the first wavelength based on the light sequentially emitted by the first group-light emitting units. In this way, the detection controller 2140 may calculate the angle-specific scattering degrees for the light having the second to fourth wavelengths.

The detection controller 2140 may calculate the angle-specific scattering degrees of light having the individual wavelengths using the intensity of light detected using the light receiving units 1 to 4_PD1 to 4 of each group. The detection controller 2140 may determine whether a fire occurs based on comparison between the angle-specific scattering degree pattern of light having the individual wavelengths and the comparison target pattern. The comparison target pattern may be, for example, the angle-specific scattering degree pattern of light having the individual wavelengths due to fire smoke.

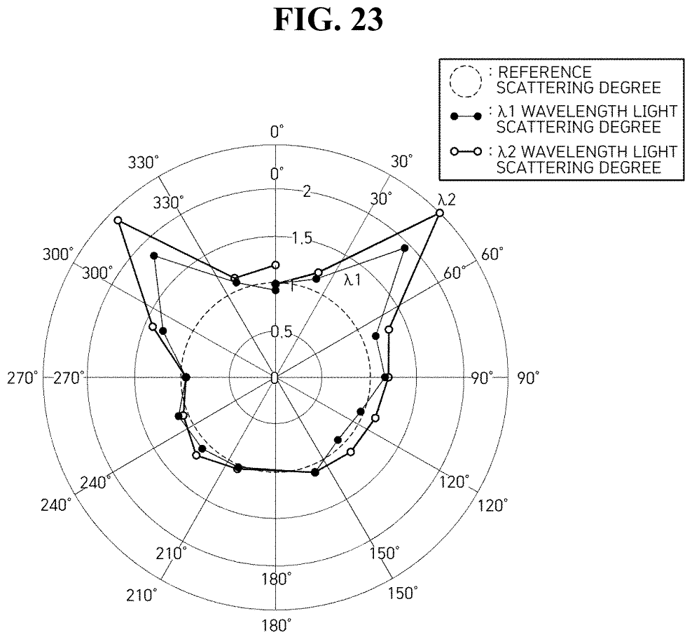

FIG. 23 is a graph illustrating an angle-specific scattering degree of light having a plurality of wavelengths according to another embodiment.

Referring to FIG. 23, it may be identified that there is a difference between the angle-specific scattering degree of light having the first wavelength and the angle-specific scattering degree of light having the second wavelength. Due to this characteristic, the detection controller 2140 according to the embodiment may determine whether a fire occurs based on the angle-specific scattering degree pattern of light having a plurality of wavelengths.

In this way, the smoke detecting apparatus 2100 according to the embodiment may accurately distinguish a fire and a non-fire from each other by analyzing smoke particles and a characteristic in which a wavelength-specific light scattering degree is changed by smoke particles. Accordingly, the smoke detecting apparatus 2100 according to the embodiment may avoid a firefighter from being incorrectly dispatched due to a false fire alarm in advance and may increase reliability of a fire alarm of the general public.

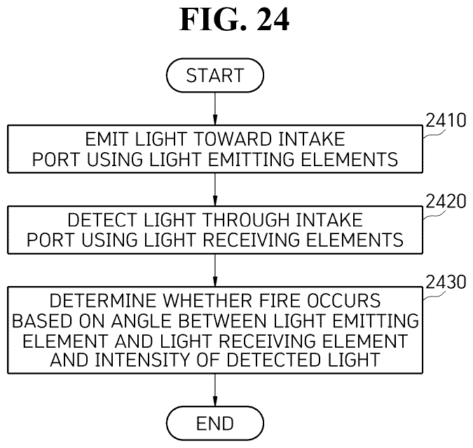

FIG. 24 is a schematic flowchart of a fire detecting method according to the embodiment.

Referring to FIG. 24, in operation 2410, the smoke detecting apparatus 1000 may emit light toward the intake port of the scattering degree measuring device 1010 through the plurality of light emitting units LED1, LED2, LED3, and LED4.

In operation 2420, the smoke detecting apparatus 1000 may detect light scattered by smoke particles in the intake port after the light is emitted to the intake port through the plurality of light receiving units PD1, PD2, PD3, and PD4.

In operation 2430, the smoke detecting apparatus 1000 may detect whether a fire occurs based on the intensity of light detected through the plurality of light receiving units PD1, PD2, PD3, and PD4 and the angles between the light emitting units and the light receiving units.

According to various embodiments, the smoke detecting apparatus 2100 may similarly calculate an angle-specific scattering degree further based on the wavelengths of light having the plurality of wavelengths.

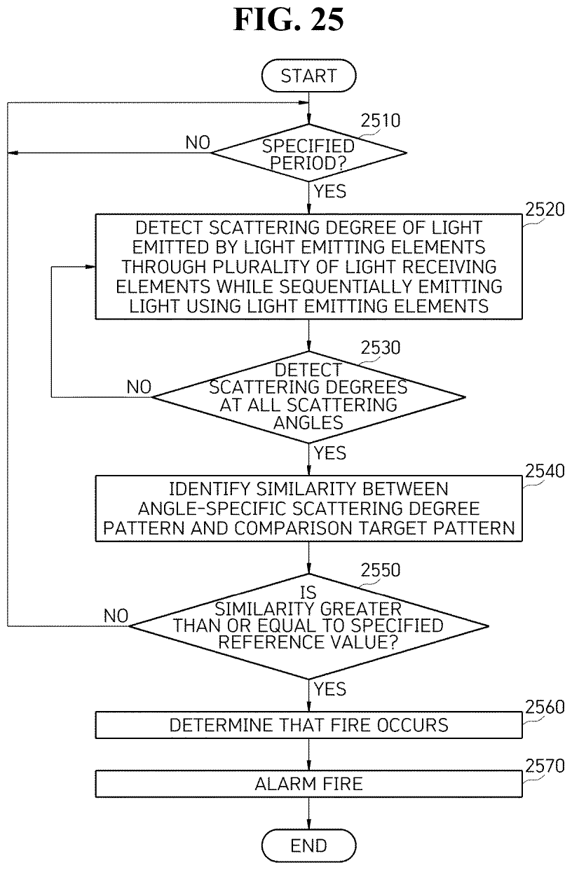

FIG. 25 is a detailed diagram of the fire detecting method according to the embodiment.

Referring to FIG. 25, in operation 2510, the smoke detecting apparatus 1000 may determine whether a specified period has arrived.

In operation 2520, when the specified period has arrived, the smoke detecting apparatus 1000 may detect the scattering degree of light emitted by the light emitting units LED1, LED2, LED3, and LED4 through the plurality of light receiving units PD1, PD2, PD3, and PD4 while sequentially emitting light using the light emitting units LED1, LED2, LED3, and LED4.

In operation 2530, the smoke detecting apparatus 1000 may identify whether the scattering degrees are detected with respect to all the scattering angles.

When the scattering degrees of light are detected with respect to all the scattering angles in operation 2530, the smoke detecting apparatus 1000 may identify the similarity between the detected angle-specific scattering degree pattern and the comparison target pattern in operation 2540. When the scattering degrees of light are not detected with respect to all the scattering angles in operation 2530, the smoke detecting apparatus 1000 may continue to detect the scattering degree of light through the plurality of light receiving units PD1, PD2, PD3, and PD4 while sequentially emitting light using the light emitting units in operation 2520.

In operation 2550, the smoke detecting apparatus 1000 may identify whether the similarity between the detected angle-specific scattering degree pattern and the comparison target pattern is greater than or equal to the specified reference value.

When it is identified that the similarity is greater than or equal to the specified reference value in operation 2550, the smoke detecting apparatus 1000 may determine that the fire occurs in operation 2560.

In operation 2560, when it is determined that the fire occurs, the smoke detecting apparatus 1000 may output a fire alarm through the output unit 1030 in operation 2570.

On the other hand, when it is identified that the similarity is not greater than or equal to the specified reference value in operation 2550, the smoke detecting apparatus 1000 may stop a fire detecting operation in a current cycle and return to operation 2510.

According to various embodiments disclosed in the present document, a fire can be detected using a plurality of light emitting units and a plurality of light receiving units. In addition, various effects directly or indirectly identified though the present document can be provided.

It should be understood that various embodiments of the present document and terms used herein are not intended to limit the technical features described in the present document to specific embodiments and include various modifications, equivalents, or alternatives of the corresponding embodiment. With regard to description of drawings, similar or related components may be marked by similar reference marks/numerals. A singular form of a noun corresponding to an item may include one or more of items unless the relevant context clearly indicates otherwise. In the present invention, phrases such as “A or B,” “at least one of A and B,” “at least one of A or B,” “A, B, or C,” “at least one of A, B, and C,” and “at least one of A, B, or C” may include any one of the items listed together in a corresponding one of the phrases or all possible combinations thereof. Such terms as “first” and “second” or “1^{st}” and “2^{nd}” may be used to simply distinguish a corresponding component from another corresponding component and does not limit the components in other aspects (for example, importance or order). When it is mentioned that a first component is “coupled” or “connected” to a second component together with or without the terms such as “functionally” or “communicatively,” this means that the first component may be connected to the second component directly (e.g., by wire), wireless, or through a third component.

The term “module” used in herein may include a unit implemented in hardware, software, or firmware, and may be used interchangeably with the terms such as logic, a logic block, a component, or a circuit. The module may be an integrally formed component or a minimum unit or a part of the component performing one or more functions. For example, according to the embodiment, the module may be implemented in the form of an ASIC.

Various embodiments of the present document may be implemented as software (e.g., a program) including one or more instructions stored in a storage medium (e.g., an internal memory or an external memory) that may be read by a machine (e.g., the smoke detecting apparatus). For example, a processor (e.g., the detection controller 1040 in FIG. 10) of the apparatus (e.g., the smoke detecting apparatus 1000) may call and execute at least one of the one or more instructions stored from the storage medium. This enables at least one function to be performed according to the at least one called instruction. The one or more instructions may include a code that is made by a compiler or a code that may be executed by an interpreter. A device-readable storage medium may be provided in the form of a non-transitory storage medium. Here, the term “non-transitory” merely means that the storage medium is a tangible device and does not include a signal (e.g., an electromagnetic wave), and this term does not distinguish a case in which data is semi-permanently stored on a storage medium and a case in which data is stored temporarily from each other.

According to the embodiment, a method according to various embodiments disclosed in the present document may be provided and included in a computer program product. The computer program product may be traded between a seller and a buyer as a product. The computer program product may be distributed in the form of the device-readable storage medium (e.g., a compact disk read only memory (CD-ROM)) or distributed (e.g., downloaded or uploaded) in an on-line manner directly through an application store (e.g., Play Store™) or between two user devices (e.g., smartphones). In the case of on-line distribution, at least part of the computer program product may be at least temporarily stored in the device-readable storage medium such as the memory of a manufacturer's server, an application store's server, or a relay server or may be generated temporarily.

Components according to various embodiments of the present document may be implemented in the form of software or hardware such as a digital signal processor (DSP), an FPGA, or an ASIC and may perform predetermined roles. The “components” are not limited to software or hardware, and each of the components may be configured in an addressable storage medium or configured to reproduce one or more processors. As an example, the components may include components such as software components, object-oriented software components, class components, and task components, as well as processes, functions, attributes, procedures, subroutines, segments of a program code, drivers, firmware, microcode, circuitry, data, database, data structures, tables, arrays, and variables.

According to various embodiments, each component (e.g., a module or a program) of the above-described components may include a single or multiple entities. According to various embodiments, one or more components or operations among the above-described components may be omitted or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations performed by modules, programs, or other components may be executed sequentially, parallelly, repeatedly, or heuristically, one or more of the operations may be executed in a different order or omitted, or one or more other operations may be added.

What is claimed is:

1. A smoke detector chamber comprising:
a scattering degree measuring device in a doughnut shape, which is provided with an intake port through which smoke particles are introduced or discharged;
a plurality of light emitting units that are fixed to the scattering degree measuring device such that light emitting areas thereof faces inside the intake port irradiated with light and emits light; and
a plurality of light receiving units that are fixed to the scattering degree measuring device such that light receiving areas thereof face inside of the intake port and, after the light is emitted, detect light scattered by the smoke particles,
wherein the plurality of light emitting units and the plurality of light receiving units are spaced apart from each other to detect a specified angle-specific scattering degree.

2. The smoke detector chamber of claim 1, wherein one light emitting unit among the plurality of light emitting units and one light receiving unit among the plurality of light receiving units are arranged to face each other, and
the other light emitting units among the plurality of light emitting units and the other light receiving units among the plurality of light receiving units are arranged not to face each other.

3. The smoke detector chamber of claim 1, wherein the number of the light emitting units is 4, and the number of the light receiving units is 4,
one light emitting unit among the plurality of light emitting units and one light receiving unit among the plurality of light receiving units face each other,
another light receiving unit is disposed at one side between the one light emitting unit and the one light receiving unit, and the other light receiving units are arranged at the other side between the one light emitting unit and the one light receiving unit, and
the other light emitting units are arranged between the one light emitting unit and the another light receiving unit.

4. The smoke detector chamber of claim 1, wherein the scattering degree measuring device includes:
an upper plate member having a plurality of first grooves in which some areas of the plurality of light emitting units and some areas of the plurality of light receiving units are seated; and
a lower plate member having a plurality of second grooves in which the other areas of the plurality of light emitting units and the other areas of the plurality of light receiving units are seated and which are coupled to the plurality of first grooves.

5. The smoke detector chamber of claim 1, wherein the scattering degree measuring device includes a housing member having a plurality of first holes in which some areas of the plurality of light emitting units and some areas of the plurality of light receiving units are seated.

6. The smoke detector chamber of claim 1, wherein the scattering degree measuring device includes a first annular member and a second annular member stacked in a direction in which the smoke particles flow,
the first annular member fixes some light emitting units, which emit light having a first wavelength, among the light emitting units and some light receiving units, which detect the light having the first wavelength, among the light receiving units, and
the second annular member fixes the other light emitting units, which emit light having a second wavelength, among the plurality of light emitting units, and the other light receiving units, which detect the light having the second wavelength, among the plurality of light receiving units.

7. A smoke detecting apparatus comprising:
a chamber in a doughnut shape, which is provided with an intake port through which smoke particles are introduced or discharged, a plurality of light emitting units and a plurality of light receiving units being spaced apart from each other and fixed to the chamber to emit light toward the intake port and receive light through the intake port; and
a controller configured to detect whether a fire occurs based on an intensity of the light detected through the plurality of light receiving units and angles between the light emitting units and the light receiving units.

8. The smoke detecting apparatus of claim 7, wherein the controller is configured to:
identify an angle-specific light scattering degree based on the angles between the light emitting units and the light receiving units and the detected intensity of the light; and
determine whether a fire occurs based on a pattern of the angle-specific light scattering degree.

9. The smoke detecting apparatus of claim 8, wherein the controller identifies the angle-specific light scattering degree by detecting scattered light using the plurality of light receiving units while controlling the plurality of light emitting units to sequentially emit light.

10. The smoke detecting apparatus of claim 9, further comprising one analog front end (AFE) element configured to amplify a signal acquired from the plurality of light receiving units,
wherein the controller detects the intensity of the light based on the signal amplified through the AFE element.

11. The smoke detecting apparatus of claim 7, wherein each of the angles is an angle between two straight lines connecting a reference point of the intake port to each of the light emitting units and each of the light receiving units.

12. The smoke detecting apparatus of claim 7, wherein the plurality of light emitting units emit light having different wavelengths, and
the controller detects whether a fire occurs further based on the wavelength of the light detected by the plurality of light receiving units.

13. The smoke detecting apparatus of claim 7, wherein the chamber fixes the plurality of light emitting units and the plurality of light receiving units, which are spaced apart from each other to measure a specified angle-specific scattering degree.

14. The smoke detecting apparatus of claim 13, wherein one light emitting unit among the plurality of light emitting units and one light receiving unit among the plurality of light receiving units are arranged to face each other, and
the other light emitting units among the plurality of light emitting units and the other light receiving units among the plurality of light receiving units are arranged not to face each other.

15. The smoke detecting apparatus of claim 13, wherein the number of the light emitting units is 4, and the number of the light receiving units is 4,
one light emitting unit among the plurality of light emitting units and one light receiving unit among the plurality of light receiving units face each other,
another light receiving unit is disposed at one side between the one light emitting unit and the one light receiving unit, and the other light receiving units are arranged at the other side between the one light emitting unit and the one light receiving unit, and
the other light emitting units are arranged between the one light emitting unit and the another light receiving unit.

16. The smoke detecting apparatus of claim 7, wherein the chamber includes a first annular member and a second annular member stacked in a direction in which the smoke particles flow,
the first annular member fixes some light emitting units, which emit light having a first wavelength, among the light emitting units and some light receiving units, which detect the light having the first wavelength, among the light receiving units, and
the second annular member fixes the other light emitting units, which emit light having a second wavelength, among the plurality of light emitting units and the other light receiving units, which detect the light having the second wavelength, among the plurality of light receiving units.

17. A method of detecting a fire by a smoke detecting apparatus including a chamber in a doughnut shape, which is provided with an intake port through which smoke particles are introduced or discharged, and a plurality of light emitting units and a plurality of light receiving units spaced apart from each other and fixed to the chamber to respectively emit light toward the intake port and receive light through the intake port,
the method comprising:
emitting light toward the intake port through the plurality of light emitting units;
after the light is emitted to the intake port, detecting, through the plurality of light receiving units, light scattered by the smoke particles in the intake port; and
detecting whether a fire occurs based on an intensity of the light detected through the plurality of light receiving units and angles between the light emitting units and the light receiving units.

18. The method of claim 17, wherein the detecting of whether the fire occurs includes:
identifying an angle-specific light scattering degree based on angles between the light emitting units and the light receiving units and the detected intensity of the light; and
determining whether a fire occurs based on a pattern of the angle-specific light scattering degree.

19. The method of claim 18, wherein the emitting of the light includes controlling the plurality of light emitting units to sequentially emit the light, and
the detecting of the light includes identifying the angle-specific light scattering degree by detecting the scattered light using the plurality of light receiving units.

20. The method of claim 17, wherein each of the angles is an angle between two straight lines connecting a reference point of the intake port and each of the light emitting units and each of the light receiving units.
